(19) United States
(12) Patent Application Publication
(10) Pub. No.: US 2013/0204813 A1
(43) Pub. Date: Aug. 8, 2013

(54) SELF-LEARNING, CONTEXT AWARE VIRTUAL ASSISTANTS, SYSTEMS AND METHODS

(71) Applicant: FLUENTIAL, LLC, Sunnyvale, CA (US)

(72) Inventors: Demitrios Leo Master, Cupertino, CA (US); Farzad Ehsani, Sunnyvale, CA (US); Silke Maren Witt-Ehsani, Sunnyvale, CA (US)

(73) Assignee: FLUENTIAL, LLC, Sunnyvale, CA (US)

(21) Appl. No.: 13/744,056

(22) Filed: Jan. 17, 2013

Related U.S. Application Data
(60) Provisional application No. 61/588,811, filed on Jan. 20, 2012.
(60) Provisional application No. 61/660,217, filed on Jun. 15, 2012.

(51) Int. Cl. G06N 99/00

(52) U.S. Cl. CPC G06N 99/005
USPC 706/12

(57) ABSTRACT

A virtual assistant learning system is presented. A monitoring device, a cell phone for example, observes user interactions with an environment by acquiring sensor data. The monitoring device uses the sensor data to identify the interactions, which in turn is provided to an inference engine. The inference engine leverages the interaction data and previously stored knowledge elements about the user to determine if the interaction exhibits one or more user preferences. The inference engine can use the preferences and interactions to construct queries targeting search engines to seek out possible future interactions that might be of interest to the user.

This application claims the benefit of priority from U.S. provisional application 61/588,811, filed Jan. 20, 2012, and U.S. provisional application 61/660,217 filed Jun. 15, 2012.

### FIELD OF THE INVENTION

The field of the invention is interaction monitoring technologies.

### BACKGROUND

The following description includes information that may be useful in understanding the present invention. It is not an admission that any of the information provided herein is prior art or relevant to the presently claimed invention, or that any publication specifically or implicitly referenced is prior art.

As mobile computing technology becomes more ever-present in our daily lives, mobile device users become more and more reliant on content obtained by their mobile devices. Ideally, mobile devices, or other monitoring technologies, should operate as a virtual assistant that observes the interactions of a user and proposes opportunities to the user based on the observations where the opportunities allow the user to discover additional interesting interactions. Such a virtual assistant would make recommendations based upon context. It would learn the preferences of the user and factor those preferences into future interactions.

Example previous work that focused merely on providing contextual recommendations include the following:
European patent application publication 2 312 476 to Salmenkaita et al. titled “Providing Recommendations”, filed Jul. 5, 2002;
U.S. Pat. No. 7,200,563 to Hammitt et al. titled “Ontology-Driven Information System”, filed Aug. 18, 2000;
U.S. Pat. No. 7,570,942 to Sorvari et al. titled “System and Method for Providing Context Sensitive Recommendations to Digital Services”, filed Aug. 29, 2002;
U.S. Pat. No. 7,609,829 to Wang et al. titled “Multi-Platform Capable Inference Engine and Universal Grammar Language Adapter for Intelligent Voice Application Execution”, filed Mar. 27, 2004;
U.S. Pat. No. 7,657,907 to Fennan et al. titled “Automatic User Profiling”, filed Sep. 30, 2002;
U.S. Pat. No. 7,805,391 to Friedlander et al. titled “Inference of Anomalous Behavior of Members of Cohorts and Associate Actors Related to the Anomalous Behavior”, filed May 30, 2008;
U.S. Pat. No. 8,032,472 to Tsui et al. titled “Intelligent Agent for Distributed Services for Mobile Devices”, filed May 18, 2008;
U.S. patent application publication 2009/0292659 to Jung et al. titled “Acquisition and Particular Association of Inference Data Indicative of Inferred Mental States of Authoring Users”, filed Sep. 23, 2008; and
U.S. patent application publication 2010/0299329 to Parson et al. titled “Method, Apparatus, and Architecture for Automated Interaction between Subscribers and Entities”, filed Feb. 13, 2009.

The above references fail to appreciate that user's preferences can be inferred. Additionally, the above cited art fails to appreciate that inferred preferences give rise to knowledge elements that can be leveraged for future exploitation with respect to future user interactions. Still, additional effort has been directed, at least at some level, toward inference of user related information.

Regarding the inference of preferences for example, in U.S. Pat. No. 7,505,921 to Andrew V. Lukas, George Lukas, David L. Klencke and Clifford Nass, titled “System and method for optimizing a product configuration”, issue date: Mar. 17, 2009, the inventors describe a method by which user preferences are inferred and continuously improved. The method is deployed in the domain of optimizing a product configuration. The method maintains records of the sequence of events that take place during a product selection process and it creates a user profile that reflects these events. Using the characteristics in the user profile, the method generated a formatted display for the user. User response to the formatted display is fed back to the user profile and the process of generating improved formatted displays is repeated iteratively until the user indicates that the product has been optimized. The approach described by Lukas et al. merely focuses on optimizing a product display and fails to abstract user preferences and the context under which these preferences are expressed. Further, the disclosed techniques fail to process implications in an unlimited set of future search queries.

A similar method is used in U.S. Pat. No. 6,021,403 to Eric Horvitz, John S. Breese, David E. Heckerman, Samuel D. Hobson, David O. Hovel, Adrian C. Klein, Jacobus A. Rommelse and Gregory L. Shaw titled “Intelligent user assistance facility”, issue date: Feb. 1, 2000. This work describes an event monitoring system that, in combination with an inference system, monitors and infers about user input sequences, current program context and the states of key data structures among other things. Of interest is the fact that user inputs can be of a multimodal nature and specifically include typed text, mouse input, gestural information, visual user information such as gaze, and user speech information input. The method computes the probabilities of user goals, intentions or information needs based on observed user actions, and other variables. The system's purpose is to monitor user interactions and program conditions in such a way as to probabilistically estimate the help or user assistance needs of the user. The system records user queries and continuously updates the user's profile across program states and subsequently customizes assistance that is offered to the user. The Horvitz approach only focuses on personalizing the help feature of a program. It also is not intended to abstract user preferences and the context under which these preferences are expressed nor process their implications in an unlimited set of future search queries.

In U.S. Pat. No. 7,672,908 issued to Anthony Slavko Tomasic and John Doyle Zimmerman, titled “Intent-based information processing and updates in association with a service agent”, issue date: Mar. 2, 2010, the inventors describe a process by which a system learns from the processing of search requests. The system collects search requests from a user and has a service agent perform the request. It then executes updates to forms and forwards information regarding the processing of the request to a learning module associated with the agent. This system processes natural language input of the search requests. The system collects or learns information about the user's intent based on the user's actions during the search request process. Although the disclosed approach describes storing the information it acquires for each user for future use by the service agent, it lacks reference to abstracting user preferences and the context under which these preferences are expressed. The approach does not process their implications in an unlimited set of future search queries.

U.S. Pat. No. 8,145,489 issued to Tom Freeman and Mike Kennewick, titled “System and method for selecting and presenting advertisements based on natural language processing of voice-based input”, issue date: Mar. 27, 2012 describes a process designed to select and present relevant advertisements, the system and method infers product preferences by processing spoken natural language search requests. User speech content and user response to the advertisement is tracked to build statistical user preference profiles that might affect subsequent selection and presentation of advertisement content. It lacks reference to abstracting user preferences and the context under which these preferences are expressed. The approach does not process their implications in an unlimited set of future search queries.

In U.S. Pat. No. 8,190,627 issued to John C. Platt, Gary W. Flake, Ramez Naam, Anoop Gupta, Oliver Hurst-Hiller, Trenholme J. Griffin and Joshua T. Goodman, titled “Machine assisted query formulation”, issue date: May 29, 2012, the inventors describe a system for completing search queries that uses artificial intelligence based schemes to infer search intentions of users where the system can process multimodal and natural language speech inputs. However this system is intended to construct search queries based primarily upon limited input. It includes a classifier that receives a partial query as input, accesses a query database based on the contents of the query input, and infers an intended search goal from query information stored on a query database. It then employs a query formulation engine that receives search information associated with the intended search goal and generates a completed formal query for execution. This system lacks reference to abstracting user preferences and the context under which these preferences are expressed. The approach does not process their implications in an unlimited set of future search queries.

In U.S. Pat. No. 6,665,640 issued to Ian M. Bennett, Bandi Ramesh Babu, Kishor Morkhandikar and Pallaki Gururaj titled “Interactive speech based learning/training system formulating search queries based on natural language parsing of recognized user queries”, issue date: Dec. 16, 2003, the inventors describe a system that accepts spoken user input and uses the input to automatically construct search queries. This system however is designed for teaching or training purposes, does not learn preferences nor learn the context under which these preferences are expressed. The approach does not process their implications in an unlimited set of future search queries and is unrelated to multipurpose, conversational virtual assistants.

U.S. Pat. No. 7,624,007 issued to Ian M. Bennett, titled “System and method for natural language processing of sentence based queries”, issue date: Nov. 24, 2009 describes a process that appears germane to query construction. The disclosed techniques describe use of a natural language engine to determine appropriate answers from an electronic database. It is intended to formulate more effective search queries. It is said to be particularly useful in the construction of Internet search queries for use in distributed computing environments. This system however is designed to use natural language processing to construct search queries. It also fails to infer user preferences, does not learn and it is unrelated to multipurpose, conversational virtual assistants. It also lacks reference to abstracting user preferences and the context under which these preferences are expressed. The approach does not process their implications in an unlimited set of future search queries.

U.S. Pat. No. 7,702,508 issued to Ian M. Bennett, titled “System and method for natural language processing of query answers”, issue date: Apr. 20, 2010 describes use of a natural language engine to determine appropriate answers that are retrieved from an electronic database using a search query. It is intended to formulate more natural and relevant search result content and not to construct search queries. It also lacks reference to abstracting user preferences and the context under which these preferences are expressed. The approach does not process their implications in an unlimited set of future search queries.

In U.S. Pat. No. 8,112,275 issued to Robert A. Kennewick, David Locke, Michael R. Kennewick, Sr., Michael R. Kennewick, Jr., Richard Kennewick, Tom Freeman, titled “System and method for user-specific speech recognition”, issue date: Feb. 7, 2012 describes a system that recognizes natural language utterances that include queries and commands and executes the queries and commands based on user-specific profiles. It also makes significant use of context, prior information, domain knowledge, and the user-specific profiles to achieve a natural environment for one or more users making queries or commands in multiple domains. Additionally, the systems and methods may create, store, and use personal profile information for different users. This information is used to improve context determination and result presentation relative to a particular question or command. Kennewick also fails to abstract user preferences in general and the context under which these preferences are expressed and fails to process their implications in an unlimited and possibly unrelated set of future search queries. Its application is also unrelated to multipurpose, conversational virtual assistants.

Additional related work attempts to combine inference, learning or acquisition of some manner of user preferences and use this information in the creation or construction of such queries. For example, U.S. publication number 2010/0299329 A1 which was issued to Dotan Emanuel, Sol Tzvi and Tal Elad, titled “Apparatus and Methods for Providing Answers to Queries Respective of a User Based on User Uniquifiers”, filing date: Feb. 26, 2010. In this work, the inventors describe a method for collecting a plurality of input information including multimodal inputs and factoring these uniquifiers into an input query. These uniquifiers are said to provide contextual value in the construction of search queries. The system also stores a record of the evaluated uniquifiers used in a search. This work however does not appear to be linked to multipurpose, conversational virtual assistants capable of factoring learned user preferences and contextual information into unlimited and possibly unrelated set of future search queries.

U.S. Pat. No. 6,968,333 issued to Kenneth H. Abbott, James O. Robarts and Dan Newell titled “Soliciting information based on a computer user's context”, issue date Nov. 22, 2005 provides another example. The inventors describe a process by which they automatically compile context information when a user provides a search request. The system then combines the contextual information with the user's search request in order to factor the contextual information into the actual search. The system creates a context awareness model where the user's contextual information is maintained. The system thus acquires contextual information that is relevant to the individual user and that can help improve the value of the user's search requests. In one embodiment, the system creates a product interest characterization that conforms to the user's reaction to search result sets. This customizing of search requests by incorporating contextual information attempts to make textual search requests more intelligent and meaningful to the user while the user is in search of a product online. Still, the Abbott approach fails to provide insight into how to abstract user preferences and the context under which these preferences are expressed or to process their implications in an unlimited set of future search queries. Its application is also unrelated to multipurpose, conversational virtual assistants.

U.S. Pat. No. 8,032,472 which was issued to Chi Ying Tsui, Ross David Murch, Roger Shu Kwan Cheng, Wai Ho Mow and Vincent Kin Nang Lau titled “Intelligent agent for distributed services for mobile devices”, issue date Oct. 4, 2011 provides yet another example. The inventors describe improving a mobile device user's experience by collecting contextual information from numerous information sources related to the mobile device user's context. This information is used to make more accurate and optimized determinations and inferences relating to which remote utilities to make available to the mobile device user. While it appears to possess some personalization abilities, it is also unrelated to multipurpose, conversational virtual assistants.

U.S. Pat. No. 8,195,468 which was issued to Chris Weider, Richard Kennewick, Mike Kennewick, Philippe Di Cristo, Robert A. Kennewick, Samuel Menaker and Lynn Elise Armstrong, titled “Mobile systems and methods of supporting natural language human-machine interaction”, issue date: Jun. 5, 2012 describes another approach. The invention is a mobile system that processes speech and non-speech multimodal inputs to interface telematics applications. The system uses context, prior information domain knowledge and user specific profile data to achieve a more natural environment for users submitting requests or commands in various domains. It also seems to possess learning or personalization ability in that it creates, stores and uses extensive personal profile information for each user, thereby improving the reliability of determining the context and presenting the expected results for a particular question or command. This invention may organize domain specific behavior and information into agents, which can be distributable or updateable over a wide area network. This work however does not appear to factor acquired user preferences into an unlimited set of future search queries and its application is also unrelated to multipurpose, conversational virtual assistants.

Yet more additional work is also described in U.S. Pat. No. 7,620,549 which was issued to Philippe Di Cristo, Chris Weider and Robert A. Kennewick, titled “System and method of supporting adaptive misrecognition in conversational speech.”, issue date: Nov. 17, 2009, U.S. Pat. No. 8,015,006 which was issued to Robert A. Kennewick, David Locke, Michael R. Kennewick, Sr., Michael R. Kennewick, Jr., Richard Kennewick, Tom Freeman, titled “Systems and methods for processing natural language speech utterances with context specific domain agents.”, issue date: Sep. 6, 2011 and in U.S. Pat. No. 8,112,275 which was issued to Robert A. Kennewick, David Locke, Michael R. Kennewick, Sr., Michael R. Kennewick, Jr., Richard Kennewick and Tom Freeman, titled “System and method for user-specific speech recognition”, issue date: Feb. 7, 2012. The latter three references focus primarily on personalization and optimization of the speech recognition process itself. This work however does not appear to factor acquired user preferences into an unlimited set of future search queries and its application is also unrelated to multipurpose, conversational virtual assistants.

Additional related work by these same inventors can be found in U.S. Pat. No. 8,140,335 which was issued to Michael R. Kennewick, Catherine Cheung, Larry Baldwin, An Salomon, Michael Tjalve, Sheetal Guttigoli, Lynn Armstrong, Philippe Di Cristo, Bernie Zimmerman, Sam Menaker, titled “System and method for providing a natural language voice user interface in an integrated voice navigation services environment”, issue date: Mar. 20, 2012 and in U.S. Pat. No. 8,155,962 which was issued to Robert A. Kennewick, David Locke, Michael R. Kennewick, Sr., Michael R. Kennewick, Jr., Richard Kennewick and Tom Freeman, titled “Method and system for asynchronously processing natural language utterances”, issue date: Apr. 10, 2012. This work however does not appear to factor acquired user preferences into an unlimited set of future search queries and its application is also unrelated to multipurpose, conversational virtual assistants.

The following four patents, U.S. Pat. No. 7,016,532 issued to Wayne C. Boncyk, Ronald H. Cohen, titled “Image capture and identification system and process”, issue date: Mar. 21, 2006; U.S. Pat. No. 7,477,780 issued to Wayne C. Boncyk, Ronald H. Cohen, titled “Image capture and identification system and process”, issue date: Jan. 13, 2009; U.S. Pat. No. 7,565,008 issued to Wayne C. Boncyk, Ronald H. Cohen, titled “Data capture and identification system and process”, issue date: Jul. 21, 2009; and U.S. Pat. No. 7,680,324 issued to Wayne C. Boncyk, Ronald H. Cohen, titled “Use of image-derived information as search criteria for internet and other search engines”, issue date: Mar. 16, 2010, all describe suitable techniques for generating queries based on recognized objects in a scene. None of this work however appears to factor acquired user preferences into an unlimited set of future search queries and its application is also unrelated to multipurpose, conversational virtual assistants.

None of the cited work provides any insight into how virtual assistants can observe or otherwise manage user preferences over time distinct from specific interactions in a manner that allows the assistant to create a discovery opportunity for future interactions. There is thus still a need for improvement in self-learning context-aware virtual assistant engines and/or systems.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods by which one can use a virtual assistant, possibly installed on a smartphone, to monitor environmental interactions of a user and to offer the user proposed future interactions. One aspect of the inventive subject matter includes a virtual assistant learning system. Contemplated systems include a knowledge database storing knowledge elements representing information associated with one or more users. A monitoring device, preferably a mobile computing device, acquires sensor data relating to the user's interactions with the environment and uses the observations to identify one or more interactions as a function of the sensor data. The system can further include one or more inference engines that infer one or more user preferences associated with the interaction based on known knowledge elements (e.g., previously expressed or demonstrated likes, dislikes, etc.) and the interaction. The preferences can be used to update knowledge elements (e.g., create, delete, add, modify, etc.). Further the inference engine can use the preferences, along with other accessible information, to construct a query targeting a search engine where the query seeks to identify possible future interactions in which the user might be interested. When a result set is returned in response to the query, the user's mobile device can be configured to present one or more items from the result set, possibly filtered according to the user's preferences.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is an overview of a virtual assistant ecosystem.

FIG. 2 illustrates a possible interaction between a user and a virtual assistant on an electronic device.

FIG. 3 is a schematic of a method of obtaining proposed future interactions from a virtual assistant.

### DETAILED DESCRIPTION

It should be noted that while the following description is drawn to a computer/server based monitoring and inference systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing an infrastructure capable of generating one or more signals that configure a mobile device to present possible interactions for a user that might be of interest to that user.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, “coupled to” and “coupled with” are construed to mean “communicatively coupled with” in a networking context.

The following disclosure describes systems and method where a mobile device such as a smart-phone or tablet computer, can be configured to continuously store information and knowledge that it gathers through interactions with its user. The following discussion presents the inventive subject matter from the perspective of a user interacting with a virtual assistant on a smart phone. One should appreciate that the roles or responsibilities of each disclosed element can be distributed across the ecosystem. For example, all capabilities or features could be integrated within a smart phone. Alternatively, portions of the capabilities can be disposed in remote servers or cloud-based systems (e.g., SaaS, PaaS, IaaS, etc.) that can be accessed over a network possibly in exchange for a fee.

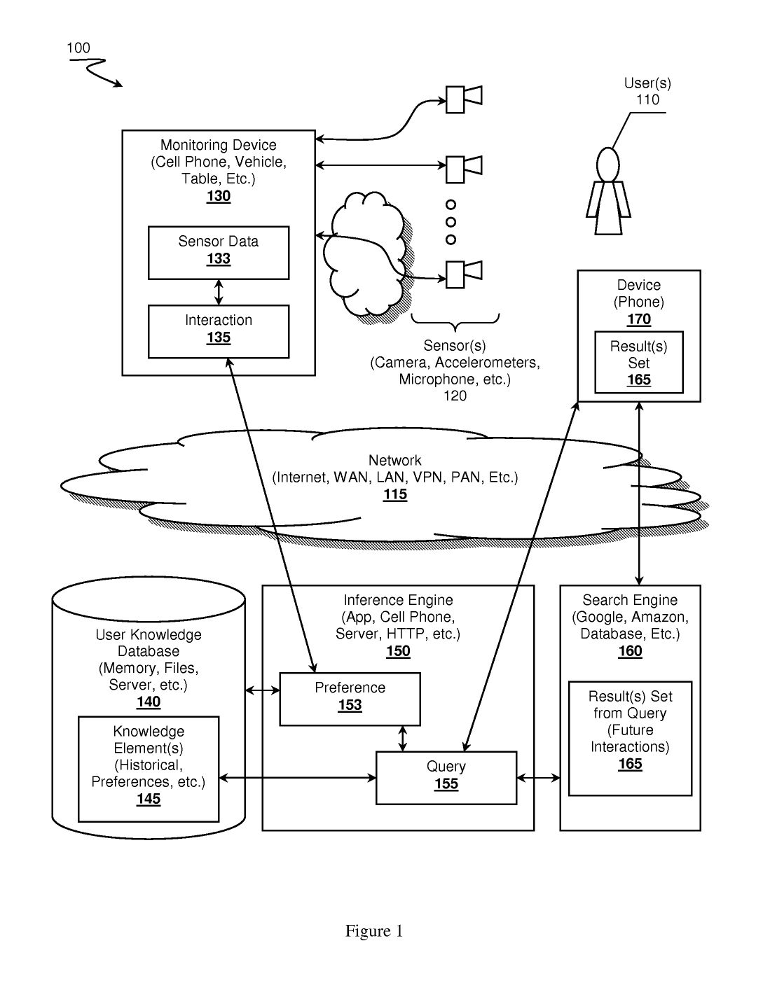

FIG. 1 illustrates virtual assistant ecosystem 100 where user 110 can interact with device 170 via a virtual assistant. Ecosystem 100 can include monitoring device 130, user knowledge database 140, and inference engine 150. As mentioned above, each of the disclosed components of the ecosystem 100 can be distributed among one or more computing devices in the ecosystem. For example, electronic device 170 can comprise monitoring device 130, inference engine 150, and even database 140. In other embodiments as shown, the elements of ecosystem 100 can be distributed across network 115 (e.g., the Internet, WAN, LAN, PAN, VPN, cellular, ad hoc, etc.).

Monitoring device 130 represents a computing device configured to observe the environment of user 110. Example computing devices that can be configured for use as monitoring device 130 include computers, tablets, smart phones, cell phones, vehicles, robots, game consoles or systems, appliances, personal sensor arrays, medical devices, point of sales devices, or other computing devices. Although monitoring device 130 is presented as distinct from electronic device 170, one should appreciate that monitor device 130 could comprise electronic device 170. For example, the roles or responsibilities of electronic device 170 and monitoring device 130 can be integrated within a single smart phone, television, game console, or other suitable computing device.

In the example shown, monitoring device 130 acquires sensor data 133 from a plurality of sensors 120 where sensor data 133 is representative of the environment of user 110. Sensor data 133 can take on many different forms depending on the nature of sensors 120. Example sensors 120 can include cameras, microphones, accelerometers, magnetometers, thermo-resisters, piezoelectric sensors, or other types of sensors 120 capable of acquiring data related to the environment. Sensor 120 can be integrated within monitoring device 130 or can be distributed throughout ecosystem 100, possibly accessible over a network as represented by the small cloud next to the bottom sensor 120. In some embodiments, monitoring device 130 could include a smart phone, possibly operating as electronic device 170, that includes one or more of sensors 120 (e.g., touch screen, accelerometers, GPS sensor, microphone, camera, etc.). In other embodiments, monitoring device 130 can include a remote computing device (e.g., a server, etc.) that acquires sensor data 133 from remote sensor 120 (e.g., stationary cameras, weather station senses, news reports, web sites, etc.). Remote sensors 120 can include fixed location sensors; traffic cameras, thermometers, or other sensors that substantially remain at fixed location. Thus, sensors 120 can include sensors disposed within monitoring device 130 or electronic device 170, or could include sensors disposed external to monitoring device 130.

In view that sensors 120 can include a broad spectrum of sensor types, one should appreciate that sensor data 133 can comprise multiple modalities, each modality corresponding to a type of data. Example modalities can include audio data, speech data, image data, motion data, temperature data, pressure data, tactile or kinesthetic data, location data, olfactory data, taste data, or other modalities of data. It should be appreciated that the sensor data modalities can comprise a representation of the real-world environment of user 110. Further, it is also contemplated that sensor data 133 can comprises a representation of a virtual environment. Thus, the modality of sensor data 133 can be, in some circumstances, considered synthetic sensor data possibly representing a virtual world (e.g., on-line game world, augmented reality, etc.). Consider scenario where user 110 is a game player within an on-line shared game world (e.g., Second Life®, World of Warcraft®). Sensor data 133 can include image data including computer generated images generated by the game client or server or even audio data between the player and other players. Such information can then be used to identify interactions 135 relevant to such a gaming context. The synthetic sensor data could include the computer generated image data, computer generated audio or speech data, or other computer generated modalities.

Monitoring device 130 can be further configured to identify interaction 135 of user 110 with the environment as a function of sensor data 133. In some embodiments, monitoring device 130 compares sensor data 133 to sensor data signatures of known types of interactions. When one or more known types of interactions have selection criteria or signatures that are satisfied by sensor data 133, matching types of interactions can be considered candidates for interaction 135. For example, user 110 could be discussing a possible purchase of a product with a close friend over the phone; electronic device 170 operating as monitoring device 130. In such an example, sensor data 133 comprises audio speech data. Monitoring device 130 can convert the audio speech data to recognized words using known Automatic Speech Recognition (ASR) techniques or algorithms. Monitoring device 130 can then submit the recognized words, possibly along with a confidence score, to an interaction database (not shown). In response, the interaction database can return one or more types of interactions that have been tagged with the same words or similar words to the recognized words. To continue the example, a recognized word such as “purchase” or “sale” could return a type of interaction object that represents a “financial transaction”. The type of interaction object can then be used to instantiate one or more of interaction 135 based on sensor data 133. Other techniques for identifying interaction 135 based on sensor data 133 are also contemplated, including using a mechanical turk system (e.g., Amazon's MTurk, see URL www.mturk.com/mturk/welcome) where humans map sensor data to interactions, mapping sensor data directly to a priori defined interactions, or other techniques.

Identification of interaction 135 can include constructing a data object, i.e., interaction 135, representative of the user interaction where a type of interaction object can be used as a template. Once the type of interaction object is obtained, monitoring device 130 can populate the fields of the template to instantiate interaction 135. Thus, interaction 135 can be considered a distinct manageable object within ecosystem 100 having fields representative of the specific circumstances. For example, interaction 135 can include metadata that is descriptive of the nature of the interaction. Example, metadata could include time stamps, identification information of user 110, a location (e.g., GPS, triangulation, etc.), an interaction identifier (e.g., GUID, UUID, etc.), triggering sensor data signature, type of interaction sensor data signature, a context, user preferences, or other information. Once identified can instantiated, interaction 135 can be packaged as a data object for storage or transmission to other elements in the ecosystem. Interaction 135 can be packaged as a serialized object possibly based on XML, JSON, or other data exchange formats.

Interaction 135 can be sent to or otherwise obtained by inference engine 150 for further analysis. Inference engine 150 infers a possible preference 153 as a function of knowledge elements 145 in database 140 and interaction 135. Knowledge elements 145 represent known information about user 110, possibly including a priori defined preferences, user identification information, historical interactions, relationships, or other information related to the user. For example, inference engine 150 can search for knowledge elements 145 representing historical interactions that are similar to interaction 135 based its attributes or properties (e.g., metadata, signatures, etc.). Then, inference engine 150 can apply one or more inference rules sets (e.g., deductive reasoning, abductive reasoning, inductive reasoning, case-base reasoning, algorithms, etc.) to determine if there might an indication of one or more of preference 153 present in the data set.

Additionally, potential preferences 153 can also be inferred by the inference engine 150 by comparing this user's preferences with the preferences of a comparable user demographics (i.e. same age, gender, education level etc). That is, if the comparable user group has preferences that are closely matching the user's preferences, new potential preferences 153 can be inferred from that and presented to the user for confirmation.

Another technique to infer preferences 153 is by matching user data from multiple sensors 133 against preference templates from the knowledge base 140. For example, if the user buys a latte most weekday mornings, that information would be encompassed by the time sensor data (weekday mornings), location sensor data (the location of the coffee shop) and purchase action (mobile wallet).

When preference 153 has been inferred from interaction 135 and knowledge elements 145, inference engine 150 can optionally attempt to validate the inference of preference 153. In some embodiments, preference 153 can be validated through querying user 110. In other embodiments, preference 153 can be validated by comparing to historical knowledge elements. For example, inference engine 150 could leverage a first portion of historical knowledge elements along with interaction 135 to infer preference 153. Then, inference engine 150 can compare preference 153 as applied to a second portion of historical knowledge elements to determine if preference 153 remains valid, possibly within a validation threshold.

As an example, consider a scenario where user 110 describes purchasing music from an on-line service to a friend over their smart phone (e.g., electronic device 170). Inference engine 150 might infer that user 110 has a preference for purchasing music or for an artist based the purchase transaction (e.g., interaction 135) and historical user data (e.g., knowledge elements 145). As inference engine 150 infers such preferences, inference engine 150 can submit the inferred preferences 153, possibly after validation, back to user knowledge database 140 as an update to the knowledge elements 145. One should also appreciate that monitoring device 130 can also be further configured to submit interaction 135 to user knowledge database 140 as an update to knowledge elements 145. Such an approach is considered advantageous because the virtual assistant ecosystem can learn from past experiences.

Although disclosed virtual assistant ecosystem 100 is capable of learning from past experiences, it is contemplated that some past experience might not be valid with respect to a current set of circumstances or possible future interactions. In some embodiments, knowledge elements 145 can incorporate one or more aging factors that can be used to determine when or at what time knowledge elements 145 might no longer be relevant or become stale. Alternatively, the aging factor can also be used to indicate that knowledge elements 145 are more relevant than others. The aging factors can be based on time (e.g., an absolute time, relative time, seasonal, etc.), use count, or other factors.

A knowledge element 145 could include a single aging factor to indicate the relevance of the knowledge element 145. For example, inference engine 140 could be configured to modify the aging factor of at least some of the knowledge elements 145 according to adjustment based on time. The adjustment can comprise a decrease in the weight of a knowledge element 145 based on time. Perhaps the knowledge element is too old to be relevant. The adjustment could also comprise an increase weight of the knowledge element based on time. Perhaps near term knowledge elements should be considered to have a greater importance with respect inferring preference 153.

It is also contemplated that knowledge elements 145 could include multiple aging factors that relate to a domain of interaction. For example, a knowledge element relating to health care (e.g., allergies, genomic information, etc.) might have an aging factor that indicates it is highly relevant regardless of the time period. However, the health knowledge element might carry little weight with respect to entertainment. Thus, knowledge elements 145 could comprise various aging factors along multiple dimensions of relevance with respect to interaction 135.

In view that user knowledge database 140 could store historical knowledge elements about user 110, inference engine 150 can monitor changes in behavior of preference 153 over time. Thus, inference engine 150 can be configured to identify one or more trends associated with preference 153 based on the historical knowledge elements. For example, inference engine 150 might only use knowledge elements 145 having an aging factor that indicate relevance within the last year to inference preference 153. Engine 150 can compare the current preference 153 to previous inferred preferences based on historical interactions of a similar nature to interaction 135. Perhaps the preference of user 110 in particular music genre has increased or decreased. Such inferred preference trends can be used for further purposes including advertising, demographic analysis, or generating query 155.

Inference engine 150 can be further configured to construct one or more of query 155 that is designed to request possible or proposed future interactions that relate to preference 153. Query 155 can be constructed based on preference 153 and information known about user 110 as found in knowledge elements 145. Further, query 155 can be constructed according to an indexing system of a target search engine 160. For example, if preference 153 indicates that user 110 is interested in a specific recording artist, inference engine 140 can generate query 155 that could require the artist name, a venue local to user 110 and a preferred price range as determined from location-based knowledge elements 145 or interaction 135. In embodiments where search engine 160 includes a publicly available search engine (e.g., Google, Yahoo!, Ask, etc.), query 155 could simply include key words. In other embodiments, query 155 can include query commands possibly based on SQL or other database query language. Further, query 155 can be constructed based on non-human readable keys (e.g., identifiers, GUIDs, hash values, etc.) to target the indexing scheme of search engine 160. It should be appreciated that search engine 160 could include a publicly available service, a proprietary database, a searchable file system, or other type of data indexing infrastructure.

Inference engine 150 can also be configured to identify a change in inferred preference trends. When the change satisfies defined triggering criteria, inference engine 150 can take appropriate action. The action could include constructing query 155 based on the change of the inferred preference trends. Such information allows for appropriate weighting or filtering of search results for proposed future interactions. As an example, if the interest of user 110 in a music genre has decreased, query 155 can be constructed to down-weight proposed future interactions relating to that genre. Additional actions beyond constructing queries include advertising to user 110, sending notifications to interested parties, or other actions.

Another preference inference technique via trends is by grouping preferences 145 in the knowledge database 140 by similar or equivalent properties. From the grouping preference can first by generalized and then additional similar preferences can be inferred by the inference engine 150 (i.e., if a user 110 has a preference for 10 different jazz musician, then he might have a preference for jazz music in general and thus additional jazz musicians).

Once query 155 is constructed or otherwise generated, inference engine 150 can use query 155 to enable electronic device to present proposed future interactions to user 110. In some embodiments, query 155 is submitted directly from inference engine 150 to search engine 160 while in other embodiments query 155 can be sent to electronic device 170, which in turn could submit query 155 to search engine 160. In response to receiving query 155, search engine 160 generates result set 165 that includes possible future interactions satisfying query 155. Future interactions could include events, purchases, sales, game opportunities, exercises, health care opportunities, changes in the law, or other interactions that user 110 might be of interest.

Interaction engine 150 enables electronic device 170 to present the proposed future interactions through various techniques. In cases where inference engine 150 sends query 155 to electronic device 170, electronic device 170 can submit the query itself and present the proposed future interactions as desired, possibly within a browser. Alternatively, inference engine 150 could receive result set 165, which can include the proposed future interactions, and can then forward the interactions on to electronic device 170. Further, inference engine 150 can alert electronic device 170 to expect result set 165 from search engine 160.

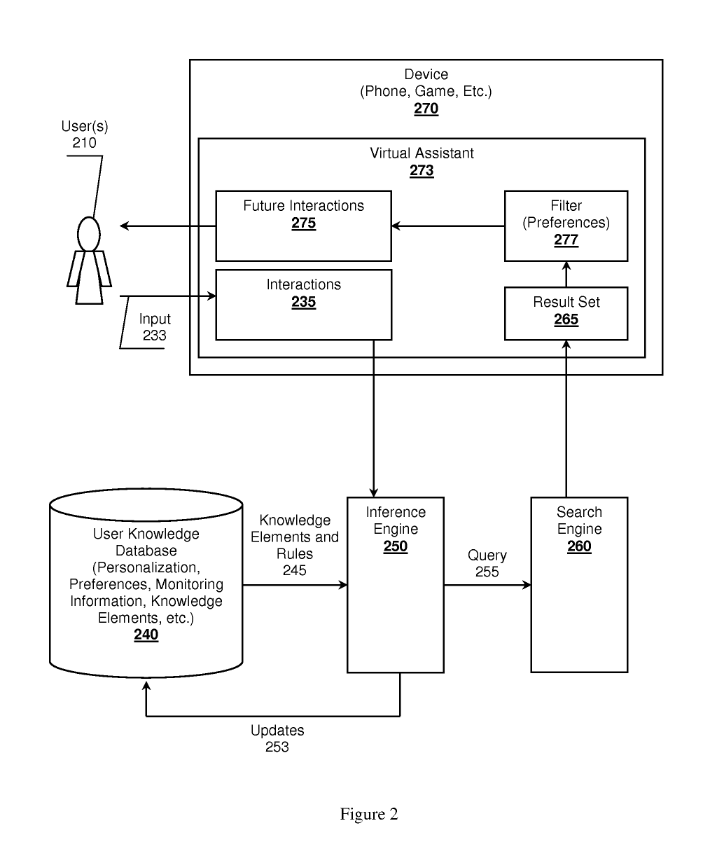

FIG. 2 provides an example of user 210 interacting with virtual assistant 273 capable of interacting with inference engine 250 as discussed above. The example is presented from the perspective of user 210 using their mobile device 270 as their point of interaction. Mobile device 270 can include a network connection capable of sending interactions 235 of user 210. As discussed above, interactions 235 can include multiple modalities: auditory, visual, kinesthetic, etc based on the form of data in input 233. In the example shown, mobile device 270 comprises sensors to acquire input 233 relevant to interactions 235. However, sensors could be external to mobile device 270 as well, possibly at fixed locations. Virtual assistant 273 can be configured to passively monitor or actively monitor any kind of task or interaction 235 the user is performing in proximity to device 270. Interactions 235 can be on or with device 270, near device 270, or indirectly involve the device 270. Examples of such tasks are buying concert tickets for a particular artist, buying gifts for children, speaking with friends, working, walking, talking, or other types of interactions.

Mobile device 270 is configured to interact with inference engine 250 to track one or more users preferences inferred from interactions 235 with the environment. Preferences can be stored within user knowledge database 240, which could include a memory of mobile device 270 or can be stored remotely on a distant computer system (e.g., server, cloud, etc.). For example, if user 210 makes a travel reservation for himself, his wife and three children, then assistant 273 would store the knowledge that user 210 has three children together with the associated birthdates or other information relating to the travel reservation (e.g., travel agency, location of trip, mode of transportation, hotels, distances, etc.). Inference engine 250 uses knowledge rules and elements 245 to aid in inferring preferences. As indicated, inference engine 250 can provide updates 253 back to database 240.

The system acquires knowledge of user preferences or context by discriminating properties of user behavior and the situational context. Discriminable properties include choices, decisions or other user behavior that is observed by the system or any discernible environmental or contextual variable values that are present when the user's response is made. Any particular observation is a knowledge element 145 which is stored for use in inferring a user's preference. Note that the inference of these user preferences is distinct form inferring facts. The disclosed methods are designed to incorporate the behavioral fact that people's preferences are evinced by their actual behavior.

Knowledge about the likes/dislikes or preferences accumulate over time and are stored in knowledge database 240. The knowledge database can be user-specific or can represent many users. Thus, knowledge elements 245 can represent information specifically about user 210 or could represent information about an aggregated group to reflect preferences of larger populations possibly segmented according to demographics.

Inference engine 250 infers one or more preferences from interactions 235 and knowledge elements 245. Each preference data element can have several attributes such as type definition (i.e. number, date, string etc.), a aging factor which indicates how long this preference data element will stay valid or how its importance decays over time and a weight that indicates importance relative to other preference data elements. Type definitions can be either of a base type (e.g. string) or of a complex data type that is derived from the base types.

An example preference data element might look like this:
Preference.NumChildren:
   type: integer
   lifespan: permanent

Data element definitions can also be unions or composites of other data elements. For example:

```
Child2:
  type:union
  elements:
    Birthdate
    PassportNum
    Gender
  lifespan: permanent
  decay: 1
```

Where Birthdate, PassportNum and Gender are in turn defined as:

```
Birthdate:
  type: Date
PassportNum:
  type: string
Gender:
  type: string
```

An example encoding of such preference data would be:
Child2.Birthdate=“12/10/2003”

Incoming data, input 233, from the user and sensors is matched against preference data elements by first identifying the correct topic via a ranking algorithm and then by matching the type of the incoming data against the data elements defined in the matching preferences topic.

Inference engine 250 has a classifier, which maps the incoming sensor data 233 to N concepts. Concepts can be seen as clusters of related sensor data. Each concept has a confidence score associated with it. The classifier can be a SVM (support vector machine), a recurrent neural net, a Bayesian classifier, or other form of classifier. These concepts with the associated sensor data and confidence scores then in turn can be matched to templates within the user knowledge database 240. For each concept a matching score can be calculated that comprises a weighted sum. This weighted sum comprises the confidence score, the number of matching data elements (input data 233) or a relevance score of the matching knowledge rules in the user knowledge database. The template that matched the concept with the highest matching score is then chosen as the winning knowledge rules or elements 245.

Knowledge about the likes/dislikes or preferences accumulate over time and can be stored in knowledge database 240. The knowledge database can be user-specific, possibly stored in the mobile device or in the cloud. Further, knowledge elements of many users can be aggregated to reflect preferences of larger populations, possibly segmented according to demographics.

The knowledge database 240 can also contain a set of predefined query types for use in constructing query 255. An example query type would be EventByArtists. As new data comes in from user 210 or sensor data, inference engine 250 can look for matching query types after the new data has been matched against the preference data. If all required data elements of a query type are matched, then the particular query type is considered to be filled and can thus activated for execution immediately, periodically, or on any other query submission criteria.

Query types can be derived from query type templates, this is similar to the behavior ontology approach described co-owned U.S. provisional application having Ser. No. 61/660,217 titled “An Integrated Development Environment on Creating Domain Specific Behaviors as Part of a Behavior Ontology” filed on Jun. 15, 2012. For example, a query type template can be a preference for a person and events associated with that person. If the user of the system then has searched for a particular person one or more times (depending on a threshold setting), the system will then create a customized version of this query type that is customized to that specific person, the person type such as singer versus actor, event type preferences, frequency preferences etc. For example, the very first time a user searches for a particular person, the frequency is set to a low frequency value. In the case of multiple searches within a predefined time period, that frequency or importance if this query is updated to a higher frequency.

Inference engine 250 communicatively couples with the knowledge database or databases 240 and couples with search engine 260: public search engines, corporate databases, web sites, on-line shopping sites, etc. Inference engine 250 uses the tracked preferences from the knowledge database 240 to construct one or more queries 255 that can be submitted to the search engine 260 in order to obtain search results possibly at periodic intervals such as weekly or monthly that relate to the user's interest. The queries 255 can also be considered interactions 235 or can be triggered by interactions 235. For example, if the user once used Shazam® to recognize a song by a particular artist, then the mobile device 270 operating as a virtual assistant 273 can present a reminder next time a concert by this artist in the user's vicinity.

Periodic queries are defined as queries where the inference engine can additionally be configured to periodically perform queries. These queries can be pre-configured and associated with each data type.

A sample query 255 for events by preferred artists could take this form:
queryElement:
   queryType: EventByArtist
   queryFrequency: monthly
   Artist: “John Lennon”
   Location: Preferences.HomeLocation
   MaxPriceRange: $200
   lifespan: 1 year
   decay factor: 0.5
   queryContent: “find concert tickets for [Artist] at [Location] in the next 6 months.

Note the actual structure of query 255 depends on the target search engine 260. Thus, query 255 could be in a human readable form or in a machine readable form. Query 255 can be submitted to search engine 260, which in turn generates one or more possible interactions in the form of result set 265. In the example shown, virtual assistant 273 can apply one or more filters 277, possibly based on user preferences set by the user, to generate proposed future interactions 275. Future interactions 275 can then be presented to user 210.

As discussed above, knowledge rules or elements 245 can also include an aging factor. For example, if the user made an inquiry about a particular artist only once six months ago, the information will have a very low weight whereas if the user made an inquiry about this artist many times over the past six months, this would be an indicator of a stronger interest or preference and thus would have a higher weight, representing its relative importance, associated with it.

One should appreciate that the weighting factors, or how the weighting factors change with time, can be adjusted heuristically to conform to a specific user. Consider a scenario where the inference engine 250 presents a new possible interaction 275 to user 210; attending a concert for example. If user 210 decides to accept the interaction, then weighting factors related to the artist, venue, cost, ticket vendor, or other aspect of the concert can be increased. If user 210 decides to reject interaction 275, the associated weighting factors can be decreased. It should be noted that the system will attempt to search for, identify or record any co-varying factors that may have predicated the user's rejection of the proposed interaction. Such contextual factors will serve to lower the weighting factors going forward. Still further, if user 210 ignores the new interaction, perhaps the parameters controlling the aging algorithm can be adjusted accordingly.

Additionally, virtual assistant 273 can have user-settable preferences as represented by filter 277, where user 210 can indicate a desired degree of activity of virtual assistant 273. For example, virtual assistant 273 may only send a weekly or daily digest of any matching information found. Alternatively, it may only report on the most active mode or have the mobile device present a pop-up whenever matching information is found such as when the mobile device enters a context having an appropriate sensor signature (e.g., time, location, speech, weather, news, etc.). As part of each pop-up or digest user 210 can also have the option to indicate whenever this information is of interest to user 210. The user's acceptance or rejection of the presented information represents the user's judgment on whether the information is of interest. These outcomes are fed back into the system to do automated learning of the details of the user's preferences and interests. By doing so, the system becomes more personalized to user 210 and its performance is improved on a by-user and per-use basis.

As a use-case, consider a scenario where the virtual assistant is running on a mobile phone. The mobile phone preferably comprises a microphone (i.e., a sensor) and captures audio data. More specifically, the mobile phone can acquire utterances (i.e., sensor data representative of the environment) from one or more individuals proximate to the mobile phone. The utterances, or other audio data, can originate from the mobile phone user, the owner, nearby individuals, the mobile phone itself (e.g., monitoring a conversation on the phone), or other entities proximate to the phone. The mobile phone is preferably configured to recognize the utterances as corresponding to a quantified meaning (i.e., identify an interaction). Thus the contemplated systems are able to glean knowledge from individuals associated with the mobile phone and accrue such knowledge for possible use in the future. Note that inputs modalities are not limited to those described in the preceding example. Virtual assistant 273 can respond to all input modalities supported by the mobile phone. These would include but are not limited to text, touch, gesture, movement, notifications, or other types of input 233.

Each time inference engine 250 receives new user input 233 or other sensor data, inference engine 250 can perform two (2) sets of operations:
Match any input data elements against all data variables in the database 240 of the same type and fill or update these as applicable.
Evaluate all knowledge rules (e.g., rule-base knowledge elements) in the system to check if any evaluates to “true”. If so, execute the respective knowledge rule. The outcome can be one of the following:
   to initiate a transaction with the user.
   to perform a search query
   to update additional values in the knowledge database

To continue the previous example, one should appreciate the expansive roles or responsibilities in the contemplated virtual assistant ecosystem. For example, inference engine 250 can engage knowledge database 240 for various purposes. In some embodiments, inference engine 250 queries knowledge database 240 to obtain information about the user's preferences, interactions, historical knowledge, or other user information. More specifically, inference engine 250 can obtain factual knowledge elements 245 such as birthdays, gender, demographic attributes, or other facts. The factual information can be used to aid in populating attributes of proposed future interactions by incorporating the factual information into future interaction templates associated with possible interactions; names for a hotel reservations, credit card information for a transaction, etc. Further, inference engine 250 also uses knowledge from knowledge database 240 as foundational elements when attempting to identify future interactions through construction of queries 255 targeting search engine 260. In such cases, inference engine 250 can apply one or more reasoning techniques to hypothesize the preferences of possible interactions of interest where the target possible interactions can be considered a hypothesis resulting from the reasoning efforts. Example reasoning techniques include case-based reasoning, abductive reasoning, deductive reasoning, inductive reasoning, or other reasoning algorithms. Once inferred preferences of a possible type of target interaction have been established, the inference engine constructs a query 255 for submission to the external sources (e.g., search engine, shopping sites, etc.) where the query 255 seeks to return actual interactions or opportunities considered to be relevant to the inferred preferences. Should user 210 choose to accept or acknowledge a returned proposed interaction 275, inference engine 250 can update the knowledge databases 240 accordingly. One should appreciate that acknowledgement by the user of the interaction 275 is also form of validation of the system's hypothesis.

An astute reader will see similarities between the operation of inference engine 250 and aspects of a human mind when recalling memories. As inference engine 250 infers the preferences or properties of hypothetical interactions of interest, inference engine 250 can use the properties to construct a query to the knowledge database 240 to seek relevant knowledge elements 245, possibly including knowledge elements representing historical interactions. Thus, inference engine 250 can be configured to recall previously stored information about interaction properties that can be used to refine (e.g., adjust, change, modify, up weight, down weight, etc.) properties used as in construction of a query 255 targeting external information sources. Furthermore, one should recall that knowledge elements can also include aging factors, which cause knowledge elements to reduce, or possibly increase, their weighted relevance to the properties of the hypothetical interactions of interest. Such an approach allows the inference engine to construct an appropriate query based on past experiences.

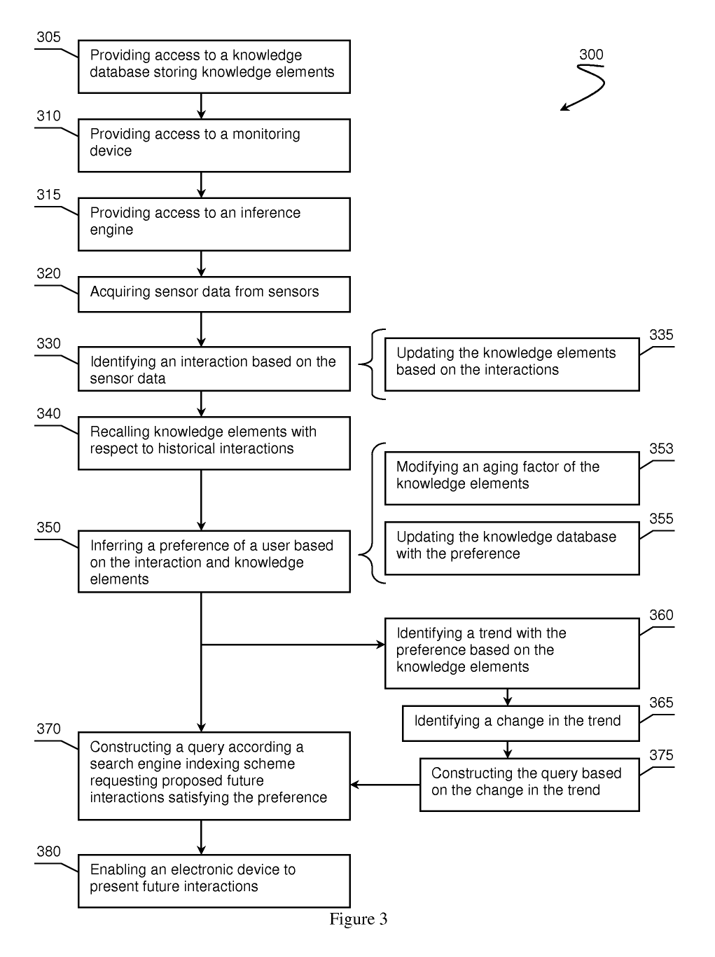

FIG. 3 illustrates a possible method 300 of interacting with a virtual assistant. Step 305 includes providing access to a knowledge database storing knowledge elements representative of a user. The knowledge database can be deployed in a user's device (e.g., memory of a smart phone) or in a remote data repository accessible over a network (e.g., Internet, LAN, WAN, VPN, etc.). The knowledge elements can be considered manageable data objects that represent aspects of a user and can include factual information (e.g., name, address, number of children, SSN, etc.), personal preferences, historical interactions, or other knowledge elements relating to a specific user or even classes of users. One should appreciate that the knowledge elements can be stored according to an indexing scheme that aids other components of the disclosed system to store or retrieve the knowledge elements. For example, the knowledge elements can be indexed according to one or more sensor data signatures. Thus, the knowledge elements can be retrieved if they have similar signatures to the sensor signatures of current or historical interactions of interest.

Step 310 includes providing access to one or more monitoring devices capable of observing a real-world, or even virtual-world, environment related to a user. In some embodiments, the monitoring device can be provided by suitably configuring a user's personal device (e.g., smart phone, game console, camera, appliance, etc.), while in other embodiments the monitoring device can be accessed over a network on a remote processing engine. The monitoring device can be configured to obtain sensor data from sensors observing the environment of the user. Further, the monitoring device can be configured to identify one or more interactions of the user with their environment as a function of the sensor data. One should appreciate that various computing devices in the disclose ecosystem can operate as the monitoring device.

Step 315 can comprise providing access to an inference engine configured to infer one or more preferences related to user's interactions with their environment. In some embodiments the inference engine can be accessed from a user's personal device over a network where the inference engine services are offered as a for-fee service. Such an approach is considered advantageous as it allows for compiling usage statistics or metrics that can be leveraged for additional value, advertising for example.

Step 320 can comprise the monitoring device acquiring sensor data from one or more sensors where the sensor data is representative of an environment related to the user. The sensor data can include a broad spectrum of modalities depending on the nature of the sensors. As discussed previously the sensor data modalities can include audio, speech, image, video, tactile or kinesthetic, or even modalities beyond the human senses (e.g., X-ray, etc.). The sensor data can be acquired from sensors integrated with the monitoring device (e.g., cameras, accelerometers, microphones, etc.) or from remote sensors (e.g., weather stations, GPS, radio, web sites, etc.)

Step 330 can include the monitoring device identifying an interaction of the user with their environment as a function of the sensor data. The monitoring device can compile the sensor data into one or more data structures representative of a sensor signature, which could also be considered an interaction signature. For example, each modality of data can be treated as a dimension within a sensor data vector where each element of the vector corresponds to a different modality or possibly a different sensor. The vector elements can be single valued or multiple valued depending on corresponding nature of the sensor. A temperature sensor might yield only a single value while an image sensor could result in many values (e.g., colors, histogram, color balance, SIFT features, etc.), or an audio sensor could result in many values corresponding to recognized words. Such a sensor signature or its attributes can then be used as a query to retrieve types of interactions from an interaction database where interaction templates or similar objects are stored according to an indexing scheme based on similar signatures. The user's interactions can be identified or generated by populating features of an interaction template based on the available sensor data, user preferences, or other aspects of the environment. Further, when new interactions are identified, the monitoring device can update the knowledge elements within the knowledge database based on the new interactions as suggested by step 335.

Step 340 can include the step of one or more devices recalling knowledge elements associated with historical interactions from the user knowledge database. For example, the inference engine or monitoring device can use the sensor data or identified interactions to recall historical interactions that could relate to the current environment circumstances. The recalled interactions can then be leveraged for multiple purposes. In some embodiments, the historical interactions can be used in conjunction with the currently identified interaction to aid in inferring preferences (see step 350 below). In other embodiments, the historical interactions or at least a portion of the historical interactions can be used to validate an inferred preference as discussed previously. Still further, the recalled historical interactions can be analyzed to determine trends in inferred user preferences over time.

Step 350 can include the inference engine inferring a preference of the user from the interaction and knowledge elements in the user knowledge database. The inferred preference can be generated through various reasoning techniques or inference rules applied to the identified interaction in view of known historical interactions or through statistical matching of the identified interaction to known similar historical interactions. In view that the historical interactions or other knowledge elements could represent knowledge that is recent or stale, each knowledge element can include one or more aging factors. As each knowledge element is used or otherwise managed, the system can modify the aging factors to indicate their current relevance or weighting of the knowledge element as suggested by step 353. Further, the system can update the knowledge database as the knowledge elements are modified or can update the knowledge database with newly generated knowledge elements; the inferred preference for example as suggested by step 355.

In some embodiments, method 300 can include identifying a trend with the inferred preferences based on the knowledge elements obtained from the user knowledge database. The inferred preferences trends can be with respect to one or more aspects of the user's experiences or interactions. For example, the inferred preferences can, in aggregate, form a contextual hierarchy that represents different scales of preferences. A top level of the hierarchy could represent a domain of interest, music or games, for example. The next level in the hierarchy could represent a genre, then artist, then song. As time marches on, the inferred preferences at each layer in the hierarchy can change, shift, or otherwise migrate from one specific topic to another. Further, the inference engine can identify a change in a trend as suggested by step 365. Consider a situation where a user has a declining preference for first person shooter (FPS) games as evidenced by reduced rate of interacting (e.g., purchasing) such FPS games. The inference engine could identify the trend as a declining interest. If the user, over an appropriate time period, begins purchasing FPS games again, the system can detect the change. Such changes can then give rise to additional opportunities such as constructing queries based on the change (step 375) to identify interactions, possibly advertisement of FPS game sales, relating to the change in the trend.

Regardless of monitoring or tracking trends, step 370 can include the inference engine constructing a query according to an indexing system of a search engine (e.g., public engine, proprietary database, file system, etc.) based on the inferred preference where the query requests a set of proposed future interactions that relate to the preference. The query can be constructed based on key words (e.g., exact terms, synonyms, etc.) targeting public search engines, on a query language (e.g., SQL, etc.), or machine readable codes (e.g., hash values, GUIDs, etc.). The constructed query can be submitted to the target search engine from the inference engine, from the user's device, or other component in the system communicatively coupled with the search engine. In response to the query, the search engine returns a result set that can include one or more proposed future interactions that satisfy the query and relate to the inferred preference.

Step 380 includes enabling an electronic device (e.g., user's cell phone, browser, game system, etc.) to present at least a portion of the proposed future interactions to a user. For example, the result set can be sent from the search engine to the electronic device directly or via the inference engine as desired. The electronic device can filter the proposed future interactions based on user defined settings. Example settings can include restrictions based on time, location, distance, relationships with others, venues, genres, artists, costs, fees, or other factors.

An example system based on the inventive subject matter discussed here is a system that aids a user with travel management. The system tracks a priori travel preferences and trips taken and regularly conducts queries for flight tickets, hotel or car reservations that match the user's preferences. Yet another example would be a food tracking application where the system learns the user's food and exercise preferences and makes appropriate suggestions. In a game, the game would learn the player's preferences as described above and instead of creating web queries the inference engine would now update the game behavior based on the learned user data.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A virtual assistant learning system comprising:
a user knowledge database storing knowledge elements associated with at least one user;
a monitoring device communicatively coupled with the user knowledge database and configured to:
acquire sensor data from a plurality of sensors, the sensor data representative of an environment; and
identify an interaction of a user with the environment as a function of the sensor data; and
an inference engine communicatively coupled with the monitoring device and the knowledge database, and configured to:
infer a preference from the interaction and knowledge elements;
construct a query according to an indexing system of a search engine and based on the preference, the query requesting a result set of proposed future interactions; and
enabling an electronic device to present at least a portion of the proposed future interactions to a user.

2. The system of claim 1, wherein the inference engine further is configured to update knowledge elements as a function of the inferred preferences.

3. The system of claim 1, wherein the monitoring device further is configured to update knowledge elements as a function of the interaction.

4. The system of claim 1, wherein the preference is derived from historical knowledge elements.

5. The system of claim 1, wherein the monitoring device comprises the electronic device.

6. The system of claim 5, wherein the electronic device comprises at least one of the following mobile devices: a cell phone, a vehicle, a table computer, a robot, game system, and a personal sensor array.

7. The system of claim 5, wherein at least some of the sensors are disposed internal to the electronic device.

8. The system of claim 1, wherein at least some of the sensors are disposed external to the monitoring device.

9. The system of claim 8, wherein at least some of the sensors comprise fixed location sensors.

10. The system of claim 1, wherein some of the knowledge elements comprise an aging factor.

11. The system of claim 10, wherein the inference engine is configured to modify the aging factor of some of the knowledge element according to an adjustment based on a time.

12. The system of claim 11, wherein the adjustment is selected from the following group: increasing a weight of the knowledge element based on time, and decreasing the weight of the knowledge element based on time.

13. The system of claim 1, wherein the sensor data comprises a representation of a real-world environment.

14. The system of claim 1, wherein the sensor data comprises a representation of a virtual environment.

15. The system of claim 1, wherein the sensor data comprises multiple modalities.

16. The system of claim 15, wherein the multiple modalities include at least two of the following: audio, speech data, image data, motion data, temperature data, pressure data, tactile data, location data, and taste data.

17. The system of claim 1, wherein the interaction comprises metadata describing the nature of the interaction.

18. The system of claim 17, wherein the metadata includes as least one of the following: a time stamp, a location, a user, an interaction identifier, a sensor data signature, a context, and a preference.

19. The system of claim 1, wherein the inference engine is further configured to identify a trend associated with the preference based on historical knowledge elements.

20. The system of claim 19, wherein the inference engine is further configured to identify a change in the trend.

21. The system of claim 20, wherein the query is constructed as a function of the change in the trend.

22. The system of claim 1, wherein the inference engine is further configured to recall knowledge elements associated with historical interactions.
